(19) United States
(12) Patent Application Publication
(10) Pub. No.: US 2005/0114277 A1
(43) Pub. Date: May 26, 2005

(54) Method, system and program product for evaluating a data mining algorithm

(75) Inventors: Feng-wei Chen Russell, Cary, NC (US); Ameet M. Kink, Sterling, VA (US); John A. Medicke JR., Raleigh, NC (US); Betsy M. Plunket, Raleigh, NC (US); Ashish Surcka, Raleigh, NC (US)

Correspondence Address: HOFFMAN WARNICK & D'ALESSANDRO, LLC, 3 E-COMM SQUARE, ALBANY, NY, 12207, US

(73) Assignee: International Business Machines Corporation, Armonk, NY (US)

(21) Appl. No.: 10/718,923

(22) Filed: Nov. 21, 2003

(51) Int. Cl. G06F 15/18; G06F 17/30; G06F 7/00; G06F 11/30; G06F 15/00

(52) U.S. Cl. 706/12; 707/5; 707/6; 702/182

(57) ABSTRACT

An improved solution for evaluating one or more data mining algorithms. A set of goals for the data mining algorithm(s) is obtained, and a weight can be assigned to each goal. Each data mining algorithm is applied to a dataset to generate a set of results. A performance value for each data mining algorithm can be calculated based on the weights and set of results. When multiple data mining algorithms are being evaluated, their respective performances can be compared using the respective sets of results and performance values.

### BACKGROUND OF THE INVENTION

1. Technical Field

The invention relates generally to evaluating a data mining algorithm, and more specifically, to a method, system and program product that allow the performance of one or more data mining algorithms to be quantified and/or compared.

2. Related Art

As businesses increasingly rely upon computer technology to perform essential functions, data mining is rapidly becoming vital to business success. Specifically, many businesses gather various types of data about the business and/or its customers so that operations can be gauged and optimized. Typically, a business will gather data into a database or the like and then utilize a data mining tool to mine the data.

Often, the data mining tool can use one of several data mining algorithms in order to mine the data. For example, the data mining algorithm can be selected based on the goals that a user is seeking to accomplish (e.g., classification, fraud detection, etc.). Making such a selection is relatively straightforward since each data mining algorithm is generally configured to fulfill specific goals. However, multiple data mining algorithms may be configured to fulfill the same goals. As a result, it is desired to select the best performing data mining algorithm for the particular data that is being mined.

Choosing the best performing data mining algorithm from a set of potential data mining algorithms is currently a time consuming and highly subjective process. In particular, a user typically runs each data mining algorithm against sample data, analyzes the results produced by each data mining algorithm, and compares the results to those produced by other data mining algorithms. To perform the analysis effectively, the user must have detailed knowledge about the goals, how the results compare to the goals, etc.

Additionally, each data mining algorithm may also be configurable by adjusting one or more tuning parameters. When such an adjustment is made, the data mining algorithm must be re-run against the sample data and the new results will need to be analyzed and compared to other results. Consequently, selecting a data mining algorithm may require several iterations of adjusting parameters for one or more data mining algorithms and analyzing and comparing the results that each run produces. Further, the user must have detailed knowledge about the way that parameter adjustments impact the performance of a data mining algorithm in order to make intelligent adjustment choices.

Due to the varying knowledge and subjectivity from user to user, selection of a data mining algorithm remains highly inefficient and inconsistent. Further, no quantifiable solution exists for evaluating the performance of a data mining algorithm that is currently in use.

As a result, a need exists for an improved solution for evaluating a data mining algorithm. In particular, a need exists for a method, system and program product for evaluating a data mining algorithm in which a performance value can be calculated for the data mining algorithm.

### SUMMARY OF THE INVENTION

The invention provides an improved solution for evaluating one or more data mining algorithms. Specifically, under the present invention, a method, system and program product are provided that calculate a performance value for each data mining algorithm. In one embodiment, a set of goals is obtained for the set of data mining algorithms. Each goal can be assigned a weight by, for example, assigning a weight to each error case for the goal. Based on the rate of errors for each error case and the associated weights, the performance value can be calculated. The performance values for multiple data mining algorithms can be compared to determine the data mining algorithms that performed best. As a result, the invention allows the performance of the data mining algorithms to be quantified and consistently compared.

A first aspect of the invention provides a method of evaluating a data mining algorithm, the method comprising: obtaining a set of goals for the data mining algorithm; assigning a weight to each goal in the set of goals; applying the data mining algorithm to a dataset; and calculating a performance value for the data mining algorithm based on the set of weights and a set of results for the applying step.

A second aspect of the invention provides a method of evaluating a set of data mining algorithms, the method comprising: selecting the set of data mining algorithms; obtaining a set of goals for the set of data mining algorithms; assigning a weight to each goal in the set of goals; applying each data mining algorithm to a dataset; and calculating a performance value for each data mining algorithm based on the set of weights and a set of results for the applying step.

A third aspect of the invention provides a system for evaluating a set of data mining algorithms having a set of goals, the system comprising: an assignment system for assigning a weight to each goal in the set of goals; an application system for applying each data mining algorithm to a dataset; and a performance system for calculating a performance value for each data mining algorithm based on the weights assigned to the set of goals and a set of results for the applying step.

A fourth aspect of the invention provides a program product stored on a recordable medium for evaluating a set of data mining algorithms having a set of goals, which when executed comprises: program code for assigning a weight to each goal in the set of goals; program code for applying each data mining algorithm to a dataset; and program code for calculating a performance value for each data mining algorithm based on the weights assigned to the set of goals and a set of results for the applying step.

The illustrative aspects of the present invention are designed to solve the problems herein described and other problems not discussed, which are discoverable by a skilled artisan.

### BRIEF DESCRIPTION OF THE DRAWINGS

These and other features of this invention will be more readily understood from the following detailed description of the various aspects of the invention taken in conjunction with the accompanying drawings that depict various embodiments of the invention, in which:

FIG. 1 shows an illustrative system for evaluating a set of data mining algorithms;

FIG. 2 shows an illustrative window for selecting a business taxonomy;

FIG. 3 shows an illustrative window for selecting a business problem;

FIG. 4 shows an illustrative window for obtaining an acceptability of errors in fulfilling a goal;

FIG. 5 shows an illustrative table for assigning weights to error cases; and

FIG. 6 shows an illustrative table for calculating a performance value.

It is noted that the drawings of the invention are not to scale. The drawings are intended to depict only typical aspects of the invention, and therefore should not be considered as limiting the scope of the invention. In the drawings, like numbering represents like elements between the drawings.

### DETAILED DESCRIPTION OF THE INVENTION

As indicated above, the invention provides an improved solution for evaluating one or more data mining algorithms. Specifically, under the present invention, a method, system and program product are provided that calculate a performance value for each data mining algorithm. In one embodiment, a set of goals is obtained for the set of data mining algorithms. Each goal can be assigned a weight by, for example, assigning a weight to each error case for the goal. Based on the rate of errors for each error case and the associated weights, the performance value can be calculated. The performance values for multiple data mining algorithms can be compared to determine the data mining algorithms that performed best. As a result, the invention allows the performance of the data mining algorithms to be quantified and consistently compared.

It is understood that as used herein, “set” is used to denote “one or more” of an object. Further, it is understood that when a “set of data mining algorithms” is discussed, the set could comprise a single data mining algorithm configured by a single set of parameters. Alternatively, the set could include a data mining algorithm that is configured using two or more distinct sets of parameter values and/or parameters. In the latter case, this could be considered a plurality of data mining algorithms.

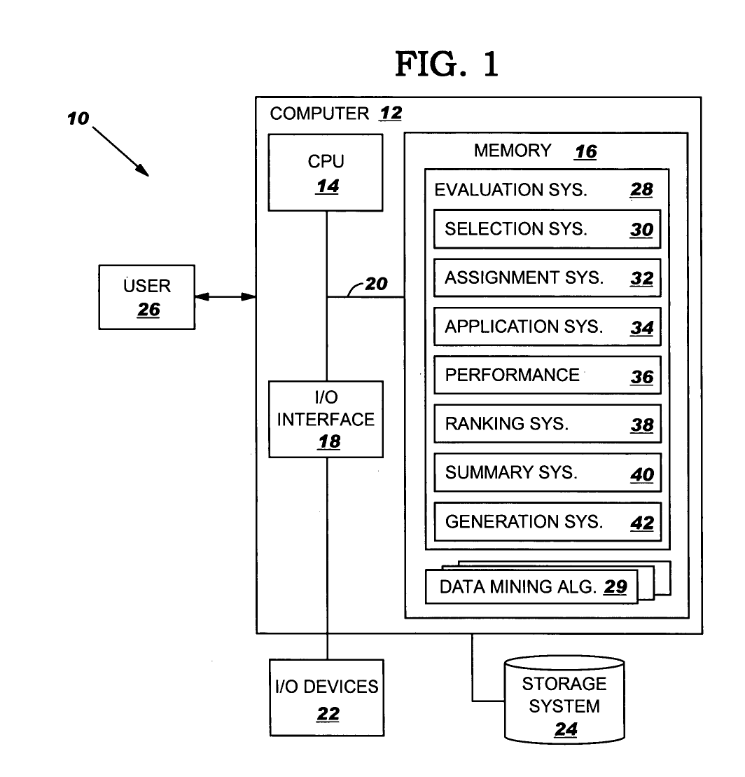

Turning to the drawings, FIG. 1 shows an illustrative system 10 for evaluating a data mining algorithm 29. As shown, computer 12 generally includes a central processing unit (CPU) 14, memory 16, input/output (I/O) interface 18, bus 20, and external I/O devices/resources 22. To this extent, computer 12 may comprise any type of general purpose/specific-use computerized system (e.g., a mobile phone, a handheld computer, a personal digital assistant, a portable (laptop) computer, a desktop computer, a workstation, a server, a mainframe computer, etc.).

CPU 14 may comprise a single processing unit, or be distributed across one or more processing units in one or more locations, e.g., on a client and server. Memory 16 may comprise any known type of data storage and/or transmission media, including magnetic media, optical media, random access memory (RAM), read-only memory (ROM), a data cache, a data object, etc. Further, computer 12 may include a storage system 24 that can comprise any type of data storage for storing and retrieving information necessary to carry out the invention as described below. As such, storage system 24 may include one or more storage devices, such as a magnetic disk drive or an optical disk drive. Moreover, similar to CPU 14, memory 16 and/or storage system 24 may reside at a single physical location, comprising one or more types of data storage, or be distributed across a plurality of physical systems in various forms. Further, memory 16 and/or storage system 24 can include data distributed across, for example, a LAN, WAN or a storage area network (SAN) (not shown).

I/O interface 18 may comprise any system for exchanging information to/from external device(s). I/O devices 22 may comprise any known type of external device, including speakers, a CRT, LED screen, handheld device, keyboard, mouse, voice recognition system, speech output system, printer, monitor/display, facsimile, pager, etc. It is understood, however, that if computer 12 is a handheld device or the like, a display could be contained within computer 12, and not as an external I/O device 22 as shown. Bus 20 provides a communication link between each of the components in computer 12 and likewise may comprise any known type of transmission link, including electrical, optical, wireless, etc. In addition, although not shown, additional components, such as cache memory, communication systems, system software, etc., may be incorporated into computer 12.

Shown stored in memory 16 is an evaluation system 28 that evaluates a set of data mining algorithms 29. To this extent, evaluation system 28 is shown including a selection system 30 that can obtain the set of data mining algorithms 29. Evaluation system 28 can also include an assignment system 32 that assigns a weight to each goal in a set of goals for the data mining algorithm(s) 29, and an application system 34 that can apply the set of data mining algorithms 29 to a sample dataset to produce a set of results for each data mining algorithm 29. Additionally, a performance system 36 can calculate a performance value for each data mining algorithm 29 based on the set of results and the weights assigned to the set of goals. Evaluation system 28 can also include a ranking system 38 for ranking the set of data mining algorithms 29, and a summary system 40 that presents at least some of the data mining algorithms 29 (e.g., best performing) to a user for review. Still further, evaluation system 28 can include a generation system 42 to generate a data mining model based on a data mining algorithm 29 selected by the user. While the various systems are shown implemented as part of evaluation system 28, it is understood that some of the various systems can be implemented independently, combined, and/or stored in memory for one or more separate computers 12 that communicate over a network. Further, it is understood that some of the systems and/or functionality may not be implemented, or additional systems and/or functionality may be included as part of evaluation system 28.

As noted previously, selection system 30 obtains a set of data mining algorithms 29 to be evaluated. In one embodiment, user 26 and/or another system can provide the set of data mining algorithms 29 to selection system 30. Alternatively, selection system 30 can select the set of data mining algorithms 29 from, for example, a plurality of data mining algorithms 29 stored in storage system 24. To this extent, the set of data mining algorithms 29 can be selected based on a business problem selected by user 26. In this case, selection system 30 can present a series of choices that allow user 26 to narrow the problem and eventually select the particular business problem. For example, selection system 30 can present a series of windows that allow user 26 to make increasingly specific selections, thereby allowing user 26 to select the set of data mining algorithms 29 in a user-friendly manner.

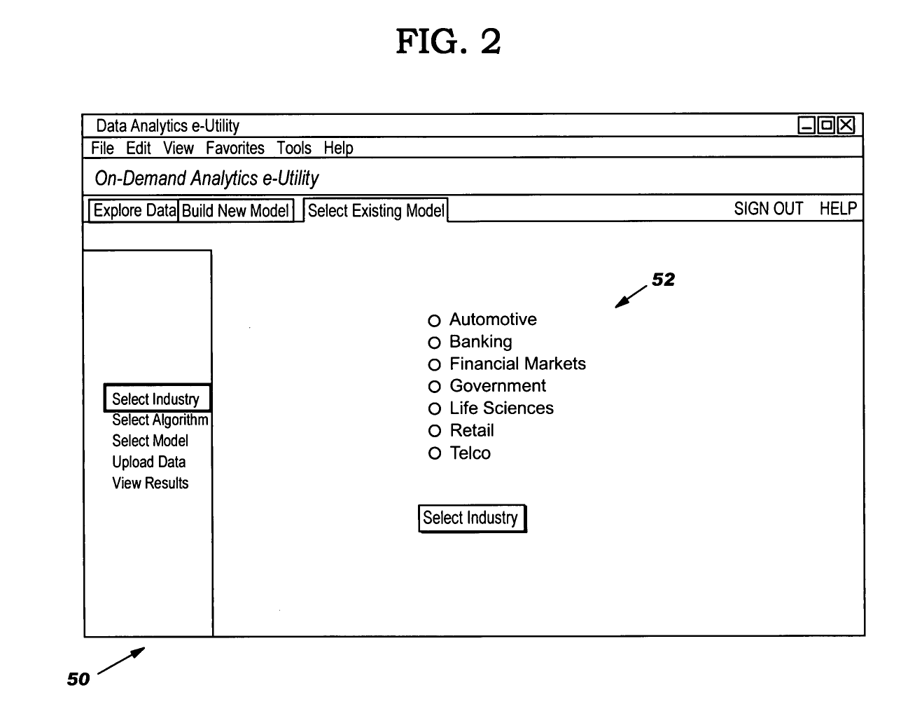

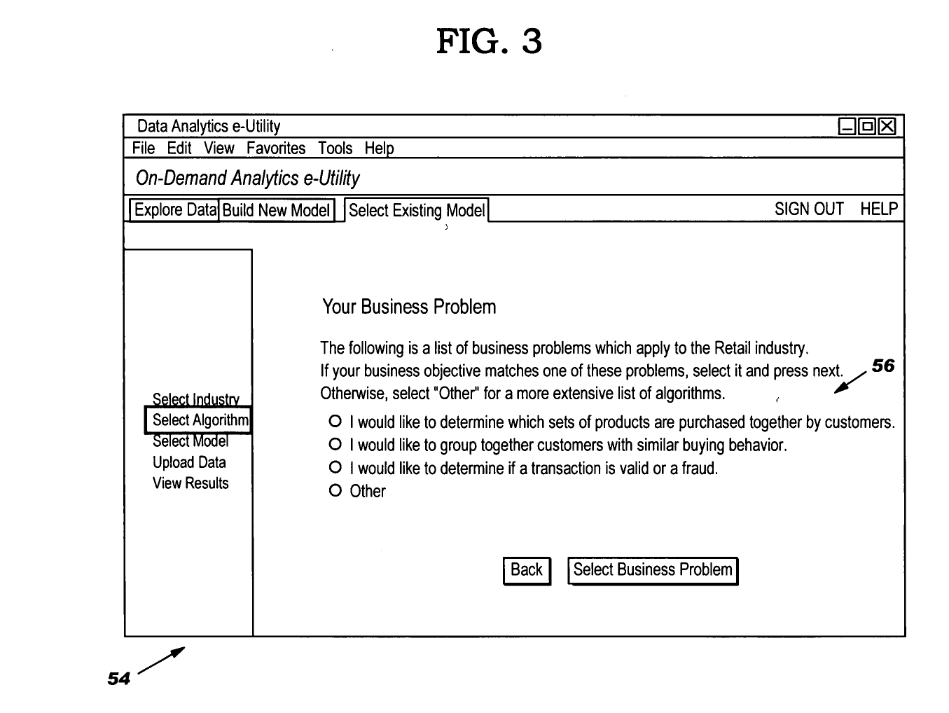

FIGS. 2 and 3 show two illustrative selection windows 50, 54. In FIG. 2, selection window 50 allows user 26 (FIG. 1) to select one of a plurality of business taxonomies 52 (e.g., industries). Business taxonomies 52 can classify the business domain into several segments according to their characteristics and/or operation types. It is understood that numerous combinations of business taxonomies 52 can be presented to user 26, and that those shown in FIG. 2 are only illustrative. In any event, once user 26 selects a business taxonomy 52 (e.g., retail), a new set of selections can be presented based on the selected business taxonomy 52. For example, FIG. 3 shows an illustrative selection window 54 that allows user 26 to select one of a plurality of business problems 56 that are common for the retail business taxonomy 52.

Once user 26 selects a business problem 56, selection system 30 (FIG. 1) can select the corresponding set of data mining algorithms 29 (FIG. 1) that solve the selected business problem 56. For example, each business problem 56 can be stored in storage system 24 (FIG. 1) along with a corresponding set of data mining algorithms 29 that are configured to solve the business problem 56. In this case, once user 26 selects business problem 56, selection system 30 can obtain an appropriate set of data mining algorithms 29 from storage system 24. Further, it is understood that an administrator or the like could manage (e.g., add, delete, modify, etc.) the stored business taxonomies 52 (FIG. 2), business problems 56, and/or data mining algorithms 29 as required.

In still another embodiment, user 26 (FIG. 1) could provide a set of goals for a data mining model, and selection system 30 (FIG. 1) can select the set of data mining algorithms 29 (FIG. 1) based on the set of goals. In particular, each data mining algorithm 29 that is configured to solve the set of goals can be selected by selection system 30. For example, user 26 could provide a goal of categorizing data. Based on the goal, selection system 30 could select each data mining algorithm 29 stored in storage system 24 that is configured to categorize data. Alternatively, the set of goals could be obtained from the selected business problem 56 and/or the set of data mining algorithms 29.

In any event, assignment system 32 (FIG. 1) can assign a weight to each goal in the set of goals for the set of data mining algorithms 29 (FIG. 1). In particular, a goal that is more important to user 26 (FIG. 1) can be given more weight, while a goal that is less important to user 26 can be given less weight. For example, the set of goals may be to determine a group of individuals that will receive a mailing requesting donations. The cost of each mailing could be $0.68, while the median donation of the donors could be $13.00. As a result, a mailing that is incorrectly sent to a non-donor would cost $0.68, while failing to send a mailing to a would be donor would cost $12.32. In this case, the goal of properly including likely donors is more important than the goal of excluding unlikely donors in evaluating the performance of a data mining algorithm 29.

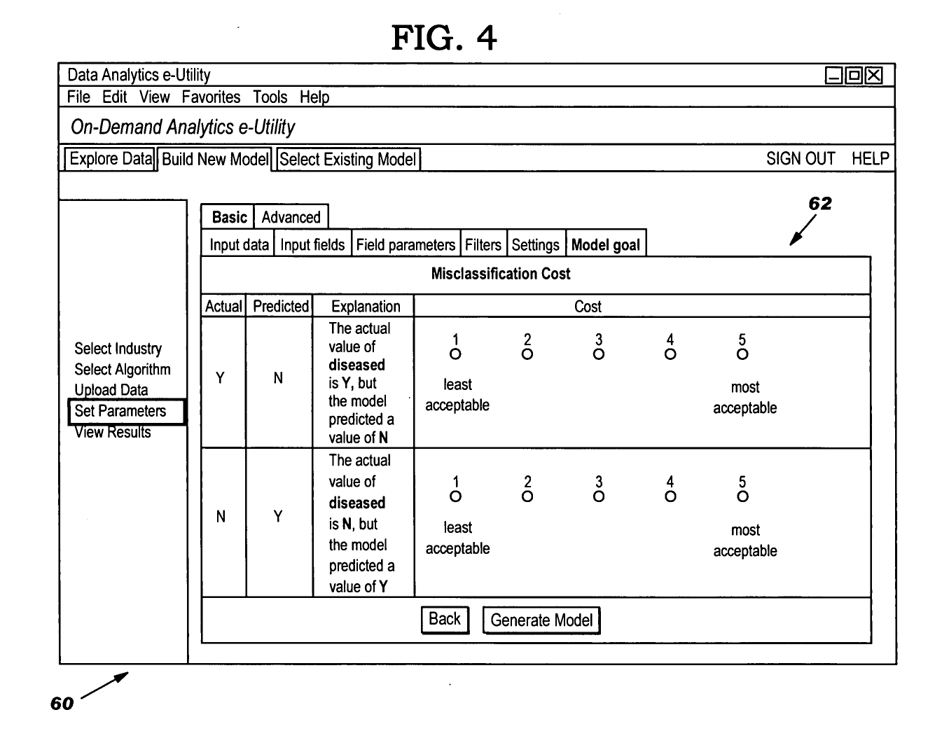

In one embodiment, a goal can be given more/less weight based on the acceptability of an error in fulfilling the goal. For example, the goal could comprise predicting if a sample is diseased. FIG. 4 shows an illustrative window 60 for obtaining an acceptability of each of the two error cases when fulfilling the goal, i.e., the sample is diseased and the data mining algorithm 29 (FIG. 1) predicts that it is not and the sample is not diseased and the data mining algorithm 29 predicts that it is. As shown in FIG. 4, user 26 (FIG. 1) can be presented with a scale 62 on which the acceptability of each error case can be selected. In this case, user 26 can select the acceptability of each error case based on, for example, the virulence of the disease, the severity of treating a non-existent disease, etc.

In order to evaluate each data mining algorithm 29 (FIG. 1), a weight can be calculated based on the acceptability. The weight will provide the relative influence that each goal, e.g., error case in attaining each goal, will have on the overall evaluation of the data mining algorithm. For example, an error rate for a particular error case can be multiplied by the weight to increase/decrease its overall impact on the evaluation of the data mining algorithm 29. In this case, an acceptability of five could translate to a weight of one since it is most acceptable, while an acceptability of one could have a weight of five since it is least acceptable.

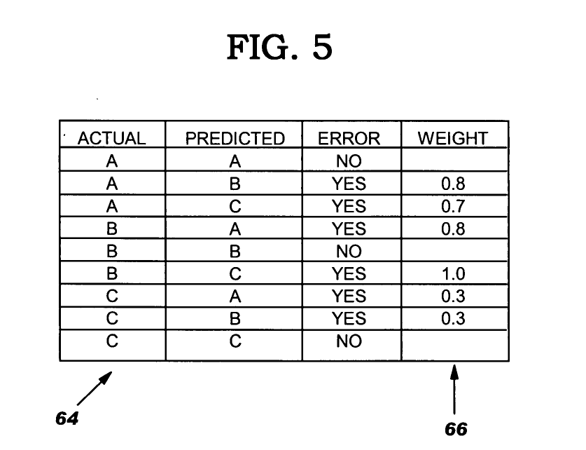

Alternatively, user 26 (FIG. 1) could provide the weight for each error case. For example, a goal could comprise a prediction for a particular value. Further, there may be limited possibilities (e.g., three) for the value. In this case, FIG. 5 shows an illustrative table 64 that assigns a weight 66 to each error case. In particular, each potential combination of predicted and actual values is determined, and each error case is identified. For each error case, user 26 can provide a value for the corresponding weight 66. It is understood that any range of values can be used for weights 66. For example, user 26 can be limited to selecting real values between zero and one, or integer values between one and one hundred. Alternatively, user 26 can be allowed to select any positive or negative value.

To evaluate the set of data mining algorithms 29 (FIG. 1), application system 34 (FIG. 1) can apply each data mining algorithm 29 to a dataset. The dataset can be provided to evaluation system 28 (FIG. 1) by user 26 (FIG. 1), and/or could be stored in storage system 24 (FIG. 1). As noted previously, the set of data mining algorithms 29 could comprise a single data mining algorithm 29 or multiple data mining algorithms 29. In the latter case, two or more data mining algorithms 29 could comprise the same data mining algorithm 29 that is applied to the dataset using two different sets of parameter values. To this extent, the two sets of parameter values can be simultaneously applied, or modified and re-applied based on a previous application. Further, when multiple data mining algorithms 29 are applied, the data mining algorithms 29 can be applied in parallel. For example, a grid computing environment can be used to maximize the throughput and response time when applying the data mining algorithms 29.

In any event, the application of each data mining algorithm 29 (FIG. 1) to the dataset generates a set of results. The set of results can include one or more data entries in which the data mining algorithm 29 failed, and one or more data entries in which the data mining algorithm 29 succeeded. Performance system 36 (FIG. 1) can calculate a performance value for each data mining algorithm 29 based on the weights assigned to the set of goals and the set of results. In one embodiment, the performance value can be based on the weights assigned to each error case as discussed above. For example, continuing with the goal of predicting a value, each data entry can be analyzed to determine the combination of predicted and actual values to which it belongs. The classified set of results can be used to determine an error rate for each error case.

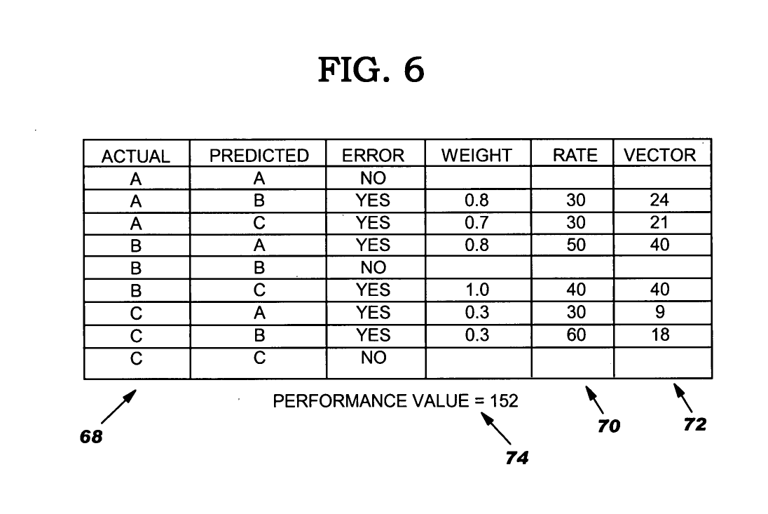

FIG. 6 shows an illustrative table 68 based on table 65 shown in FIG. 5, but that also includes an error rate 70 for each error case. The error rate 70 can be calculated, for example, by determining the total number of an actual value that are present in the dataset, and calculating a percentage of the total number that were predicted by the data mining algorithm 29 (FIG. 1) to have the corresponding incorrect value. For example, in FIG. 6, the “A” values in the dataset may have been incorrectly predicted to be “B” thirty percent of the time, and incorrectly predicted to be “C” thirty percent of the time.

Performance system 36 (FIG. 1) can apply the appropriate weight to each error rate 70 in order to calculate a performance value 74. For example, table 68 can further include an error vector 72 for each error case. The error vector 72 can be based on its corresponding error rate 70 and error weight 66 (FIG. 5). In one embodiment, each error vector 72 can be calculated by multiplying the error rate 70 by the corresponding error weight 66. The error vectors 72 can then be used to calculate performance value 74. For example, error vectors 72 can be summed to obtain performance value 74 as shown in FIG. 6. Performance value 74 is used to evaluate each data mining algorithm 29 (FIG. 1). For example, a lower performance value 74 could indicate that the performance of a data mining algorithm 29 more closely matched the weighted goals. However, it is understood that performance value 74 can be calculated using any solution.

In any event, ranking system 38 (FIG. 1) can rank the set of data mining algorithms 29 (FIG. 1) based on their corresponding performance values 74. For example, when a lower performance value 74 indicates better performance, the set of data mining algorithms 29 can be ordered from lowest performance value 74 to highest performance value 74. Further, user 26 (FIG. 1) could provide an acceptable performance value to ranking system 38. Any data mining algorithm 29 that has a performance value 74 outside the range (e.g., higher) defined by the acceptable performance value can be discarded. If only one data mining algorithm 29 has a performance value 74 within the range, the data mining algorithm 29 can be selected to generate a data mining model as discussed further below.

One or more data mining algorithms 29 (FIG. 1) can be provided to summary system 40 (FIG. 1) for displaying the performance value(s) 74 to user 26 (FIG. 1). For example, each data mining algorithm 29 having a performance value 74 within the acceptable performance range can be displayed to user 26. Alternatively, a predetermined number of the best performing data mining algorithms 29 or all data mining algorithms 29 can be displayed to user 26. Summary system 40 can allow user 26 to select one or more data mining algorithms 29 for modification and re-application by application system 34 (FIG. 1), or user 26 can select a data mining algorithm 29 to generate a data mining model.

To this extent, generation system 42 (FIG. 1) can generate the data mining model based on the selected data mining algorithm 29 (FIG. 1). The data mining model can comprise, for example, a set of standard query language (SQL) statements that implement the selected data mining algorithm 29. Once generated, the data mining model can be deployed for use by a company. For example, a business may start using the results produced by a data mining model in a call center, web application, brick and mortar store, etc. to increase the benefit derived from data available at these locations.

It is understood that the present invention can be realized in hardware, software, or a combination of hardware and software. Any kind of computer/server system(s)—or other apparatus adapted for carrying out the methods described herein—is suited. A typical combination of hardware and software could be a general-purpose computer system with a computer program that, when loaded and executed, carries out the respective methods described herein. Alternatively, a specific use computer (e.g., a finite state machine), containing specialized hardware for carrying out one or more of the functional tasks of the invention, could be utilized. The present invention can also be embedded in a computer program product, which comprises all the respective features enabling the implementation of the methods described herein, and which—when loaded in a computer system—is able to carry out these methods. Computer program, software program, program, or software, in the present context mean any expression, in any language, code or notation, of a set of instructions intended to cause a system having an information processing capability to perform a particular function either directly or after either or both of the following: (a) conversion to another language, code or notation; and/or (b) reproduction in a different material form.

The foregoing description of various embodiments of the invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of the invention as defined by the accompanying claims.

1. A method of evaluating a data mining algorithm, the method comprising:
obtaining a set of goals for the data mining algorithm;
assigning a weight to each goal in the set of goals;
applying the data mining algorithm to a dataset; and
calculating a performance value for the data mining algorithm based on the set of weights and a set of results for the applying step.

2. The method of claim 1, wherein the assigning step includes:
identifying a set of error cases for each goal in the set of goals; and
assigning a weight to each error case in the set of error cases.

3. The method of claim 2, wherein the assigning step includes:
obtaining an acceptability for an error case; and
calculating the weight based on the acceptability.

4. The method of claim 2, wherein the calculating step includes:
determining an error rate for each error case based on the set of results; and
calculating an error vector for each error case based on the error rate and error weight for the error case.

5. The method of claim 4, wherein the calculating step further includes summing the error vectors for the set of error cases to obtain the performance value.

6. The method of claim 1, further comprising comparing the performance value to an acceptable performance value.

7. A method of evaluating a set of data mining algorithms, the method comprising:
selecting the set of data mining algorithms;
obtaining a set of goals for the set of data mining algorithms;
assigning a weight to each goal in the set of goals;
applying each data mining algorithm to a dataset; and
calculating a performance value for each data mining algorithm based on the set of weights and a set of results for the applying step.

8. The method of claim 7, wherein the selecting step is based on the set of goals.

9. The method of claim 7, wherein the selecting step includes:
selecting a business taxonomy;
selecting a business problem based on the business taxonomy; and
selecting the set of data mining algorithms based on the business problem.

10. The method of claim 7, further comprising ranking the set of data mining algorithms based on the performance values.

11. The method of claim 7, wherein the assigning step includes:
identifying a set of error cases for each goal; and
assigning a weight to each error case in the set of error cases.

12. The method of claim 7, wherein the set of data mining algorithms includes at least one data mining algorithm having a first set of parameter values and the at least one data mining algorithm having a second set of parameter values.

13. The method of claim 7, further comprising:
selecting a data mining algorithm in the set of data mining algorithms; and
generating a data mining model based on the selected data mining algorithm.

14. A system for evaluating a set of data mining algorithms having a set of goals, the system comprising:
an assignment system for assigning a weight to each goal in the set of goals;
an application system for applying each data mining algorithm to a dataset; and
a performance system for calculating a performance value for each data mining algorithm based on the weights assigned to the set of goals and a set of results for the applying step.

15. The system of claim 14, further comprising a selection system for selecting the set of data mining algorithms.

16. The system of claim 14, further comprising a ranking system for ranking the set of data mining algorithms based on the performance values.

17. The system of claim 14, further comprising a summary system for displaying the performance values for at least some of the set of data mining algorithms to a user.

18. The system of claim 14, further comprising a generation system for generating a data mining model based on a data mining algorithm selected from the set of data mining algorithms.

19. The system of claim 14, wherein the application system applies the set of data mining algorithms in parallel.

20. A program product stored on a recordable medium for evaluating a set of data mining algorithms having a set of goals, which when executed comprises:
program code for assigning a weight to each goal in the set of goals;
program code for applying each data mining algorithm to a dataset; and
program code for calculating a performance value for each data mining algorithm based on the weights assigned to the set of goals and a set of results for the applying step.

21. The program product of claim 20, further comprising program code for selecting the set of data mining algorithms.

22. The program product of claim 20, further comprising program code for ranking the set of data mining algorithms based on the performance values.
